(19) United States
(12) Patent Application Publication
(10) Pub. No.: US 2011/0219235 A1
(43) Pub. Date: Sep. 8, 2011

(54) DIGITAL SIGNATURE DEVICE, DIGITAL SIGNATURE METHOD, AND NON-TRANSITORY STORAGE MEDIUM STORING DIGITAL SIGNATURE PROGRAM

(75) Inventors: Kazuma TAKAHASHI, Takamatsu (JP); Kazuo Yamakawa, Takamatsu (JP); Isao Sumito, Takamatsu (JP)

(73) Assignee: FUJITSU LIMITED, Kawasaki (JP)

(21) Appl. No.: 13/038,949

(22) Filed: Mar. 2, 2011

(30) Foreign Application Priority Data
Mar. 4, 2010 (JP) 2010-48180

(51) Int. Cl. G06F 17/30

(52) U.S. Cl. 713/176

(57) ABSTRACT

A digital signature device includes an operation unit configured to accept key information that specifies target information of digital signature from a user and to accept the digital signature from the user, a control unit configured to extract one or more values that correspond to the key information that is accepted, from a database that stores a plurality of pieces of key information that includes the key information in association with each value, to calculate a characteristic value that is uniquely defined for the value based on the one or more values that are extracted, and to generate signature data that includes the key information, the characteristic value, and information for the digital signature for each of the one or more values, and a storage unit configured to store the signature data.

### CROSS-REFERENCE TO RELATED APPLICATIONS

This application is based upon and claims the benefit of priority of the prior Japanese Patent Application No. 2010-48180, filed on Mar. 4, 2010, the entire contents of which are incorporated herein by reference.

### FIELD

The embodiments discussed herein relate to a digital signature device, a digital signature method, and a storage medium that stores a digital signature program to apply digital signatures on a group of records in a database.

### BACKGROUND

Recently, electronic file systems have been used for various businesses such as clinical trial business operations. The clinical trial business operations include a process to collect clinical trial data which is an original document, a process to create an analysis document by cleaning the collected clinical trial data, and a process to create a final document to submit to public agencies based on the analysis document.

The data obtained at each process is registered in databases and updated as needed. Required data is extracted from the databases when contents registered in the databases are established and electronic files need to be submitted to public agencies. An operation to record the extracted data as files is performed.

Japanese Laid-open Patent Publication No. 2007-34933 discusses a technology that prevents an improper use of a content of an electronic file. Moreover, Japanese Laid-open Patent Publication No. 2006-127365 discusses a technology that applies a digital signature to an electronic file and prevents falsification and spoofing. For the clinical trial business operations, a digital signature is applied as well when an electronic file is submitted to public agencies.

### SUMMARY

According to an aspect of the invention, a digital signature device includes an operation unit configured to accept key information that specifies target information of a digital signature from a user and to accept the digital signature from the user; a control unit configured to extract one or more values that correspond to the key information that is accepted, from a database that stores a plurality of pieces of key information that includes the key information in association with each of the extracted values, to calculate a characteristic value that is uniquely defined for each value based on the one or more values that are extracted, and to generate signature data that includes the key information, the characteristic value, and information for the digital signature for each of the one or more values; and a storage unit configured to store the signature data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a hardware configuration of a digital signature device according to an embodiment.

FIGS. 2A to 2C are schematic views of examples of data tables for respective databases.

FIG. 3 is a flow chart illustrating a processing procedure of a digital signature.

FIG. 4 is a schematic view of an example of information that is accepted when a digital signature target record group is specified.

FIG. 5 is a schematic view of an example of a search result.

FIG. 6 is a schematic view of an example of a management table.

FIG. 7 is a flow chart illustrating a processing procedure of a falsification determination.

### DESCRIPTION OF EMBODIMENTS

Digital signatures have not been directly applied to data stored in databases and there is no method to determine whether data is falsified before data is recorded in a final file.

This is because databases used for businesses are frequently updated and contents stored in the databases cannot be fixed. Moreover, systems used for businesses provide certain authentication functions and thereby may prevent spoofing. Accordingly, taking out a database itself is difficult, and a risk that the database is falsified by an outsider is low.

As described above, conventionally, falsifications by outsiders may be prevented by the authentication functions. However, there is a drawback in which falsifications by an insider (person in charge of the business) can not be prevented.

The inventors propose a digital signature device, a digital signature method and a storage medium that stores a digital signature program that allow to apply digital signatures on data in a database.

Hereinafter, an embodiment in which a digital signature is applied on data in a database used by clinical trial business operations will be specifically described by referring to drawings.

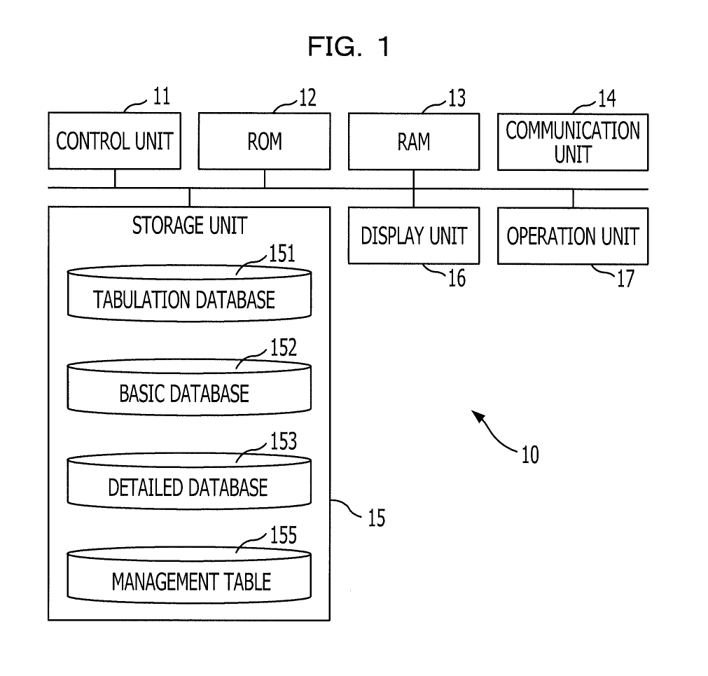

FIG. 1 illustrates an example of a hardware configuration of a digital signature device according to an embodiment. A digital signature device 10 according to the embodiment includes a control unit 11, a Read Only Memory (ROM) 12, a Random Access Memory (RAM) 13, a communication unit 14, a storage unit 15, a display unit 16 and an operation unit 17. These components are interconnected with each other through a bus.

The control unit 11 includes a Central Processing Unit (CPU) or a Micro Processing Unit (MPU). When an MPU is included, the ROM 12 and the RAM 13 may be incorporated in the control unit 11.

The control unit 11 reads a digital signature program and data stored in the ROM 12 or the storage unit 15, writes to the RAM 13, executes the digital signature program and the data, and controls operations of each of the above described hardware components.

The ROM 12 stores desired computer programs to operate the digital signature program and each of the above described hardware components.

According to the embodiment, the digital signature program and various computer programs are stored in the ROM 12. However, the digital signature program and various computer programs may be stored in the storage 15.

The RAM 13 is, for example, a Dynamic RAM (DRAM), a Static RAM (SRAM), and a flash memory to which various data that is generated when the control unit 11 executes the digital signature program and various computer programs is temporarily stored. The various data is, for example, computation results, various parameters, and damp data which will be described later.

The communication unit 14 includes a communication interface to communicate with a wired or wireless external communication network.

The operation unit 17 includes an input interface to accept an input of information. The operation unit 17 is, for example, a keyboard. The display unit 16 displays information that is input through the operation unit 17 by an instruction from the control unit 11, and information to be notified to users. The display unit 16 is, for example, a liquid crystal display.

The display unit 16 and the operation unit 17 provide interfaces with users. The digital signature device 10 may accept input operations from other devices and perform output operations to other devices through a network.

The storage unit 15 is a nonvolatile storage device such as a hard disk or a flash memory. A portion of storage areas of the storage unit 15 is used for a tabulation database 151, a basic database 152, a detailed database 153, and a management table 155.

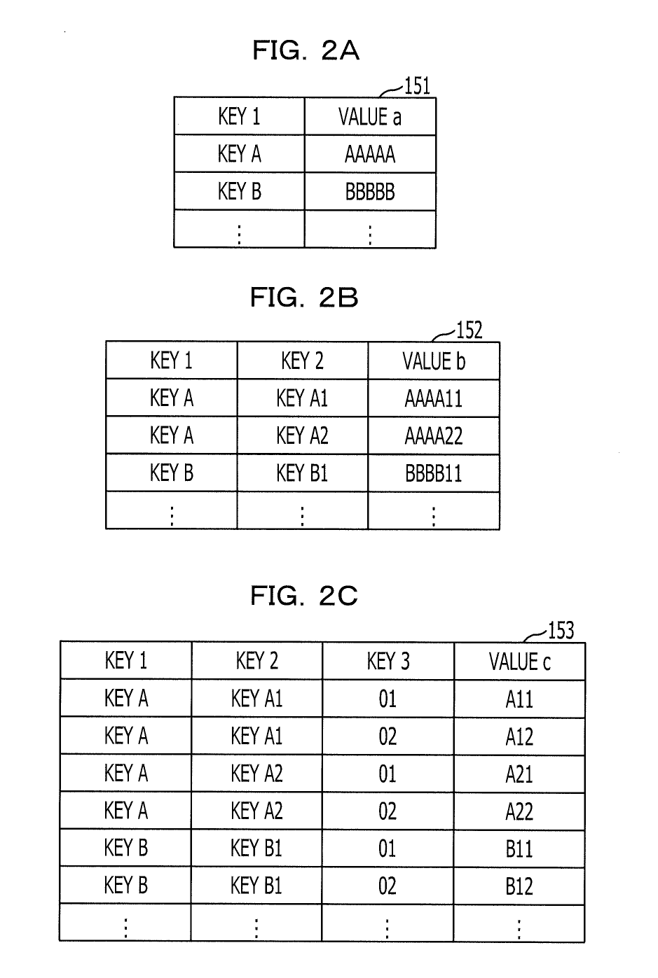

FIGS. 2A to 2C are schematic views of examples of data tables for respective databases. FIG. 2A illustrates an example of a tabulation database 151. The tabulation database 151 stores a “Key1” in association with a “value a.” The “Key 1” in the tabulation database 151 stores information such as frequency of administration and administered drug names. The “value a” stores symptoms after administering the drug and a degree of improvement after administering the drug. The information to be stored is collected, for example, by pharmaceutical companies and hospitals and is input as needed to the digital signature device 10 through the communication unit 14 or the operation unit 17. The input information is stored in the tabulation database 151. In other words, information stored in the tabulation database 151 is updated as needed.

According to the embodiment, the “Key1” is stored in the tabulation database 151 in association with the “value a.” However, three or more pieces of information may be associated and stored in the tabulation database 151.

FIG. 2B is an example of the basic database 152. The basic database 152 associates and stores a “Key 1”, a “Key 2” and a “value b.” The “Key 2” stores information such as a patient's name, a company name that administers the drug, and a hospital name that administers the drug. The “value b” stores information such as a height, a weight, and a sex of a patient to whom the drug is administered. The information to be stored, for example, is input to the digital signature device 10 through the communication unit 14 or the operation unit 17 as basic information and is stored in the basic database 152 when starting the administration. In other words, information stored in the basic database 152 is updated as needed.

Information stored in the basic database 152 and information stored in the tabulation database 151 are associated with each other through the “Key 1.”

According to the embodiment, the two pieces of information, “Key 2” and “value b” are stored in association with the “Key 1.” However, three or more pieces of information may be stored in association with the “Key 1.”

FIG. 2C is an example of the detailed database 153. The detailed database 153 associates and stores the “Key 1”, “Key 2”, “Key 3”, and “value c.” The “Key 3” stores information such as date and time of administration and administered dose. The “value c” stores blood pressure, body temperature, and blood composition after administering the drug. The information to be stored is collected, for example, by pharmaceutical companies and hospitals and is input as needed to the digital signature device 10 through the communication unit 14 or the operation unit 17. The input information is stored in the tabulation database 151. In other words, information stored in the detailed database 153 is updated as needed.

Information stored in the detailed database 153, that stored in the tabulation database 151, and that stored in the basic database 152 are associated with each other through the “Key 1” and “Key 2”.

According to the embodiment, the two pieces of information, “Key 3” and “value c” are stored in association with the “Key 1” and the “Key 2.” However, three or more pieces of information may be stored in association with the “Key 1” and “Key2.”

According to the embodiment, three databases are provided in the storage unit 15 of the digital signature device 10. However, configurations of databases are not limited to those described above. One database may associate and store a plurality of pieces of information.

The tabulation database 151, the basic database 152, and the detailed database 153 may be included in another computer connected through a communication network such as a Local Area Network (LAN) and the Internet. The digital signature device 10 accesses the databases through the communication unit 14 and retrieves information stored and associated in the databases.

Moreover, according to the embodiment, as illustrated in FIGS. 2a-c, a database that employs a relational data model is used. However, a database with any data model may be employed. For example, a hierarchical data model, a network type data model, and a card type data model may be employed.

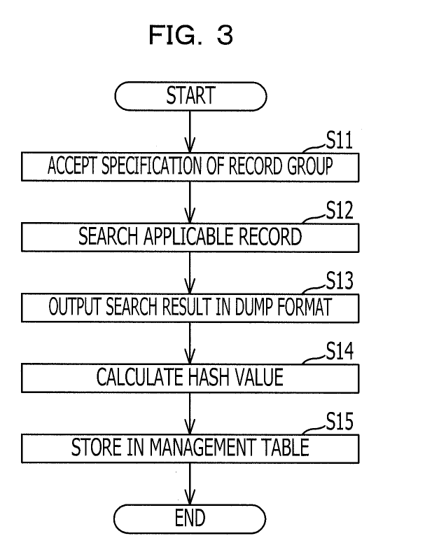

Hereinafter, processing executed by the digital signature device 10 according to the embodiment will be described. FIG. 3 is a flow chart illustrating a processing procedure of a digital signature. The operation unit 17 of the digital signature device 10 accepts information that specifies a digital signature target record group (S11). Here, the digital signature target record group indicates a series of information among information that is associated and stored at the time in the each of the databases 151 to 153 that needs to be certified that no falsification is made. When the digital signature device 10 is used for clinical trial business operations, for example, in order to ensure validity of clinical trial data for each visit, a selection of information to which a digital signature is applied is accepted at operation S11. It is assumed that a signer has a valid authority and no identity theft is taken place.

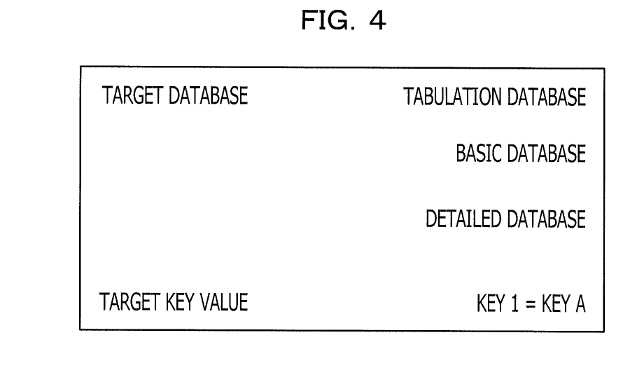

FIG. 4 is a schematic view of an example of information that is accepted when a digital signature target record group is specified. According to the embodiment, information that specifies a target database and a key that specifies target information from a user are accepted. In the example illustrated in FIG. 4, the tabulation database 151, the basic database 152, and a detailed database 153 are specified as target databases, and “Key A” is specified among information stored in the key 1 as a search target key.

According to the embodiment, all of the three databases are specified. However, for example, the database 152 may be excluded from the digital signature targets when there is no need to certify validity of information of a “value b” stored in the basic database 152. Moreover, according to the embodiment, a database that is a digital signature target is specified as well. However, typically a specification of a search key is accepted and a database that includes information specified by the search key may be automatically specified.

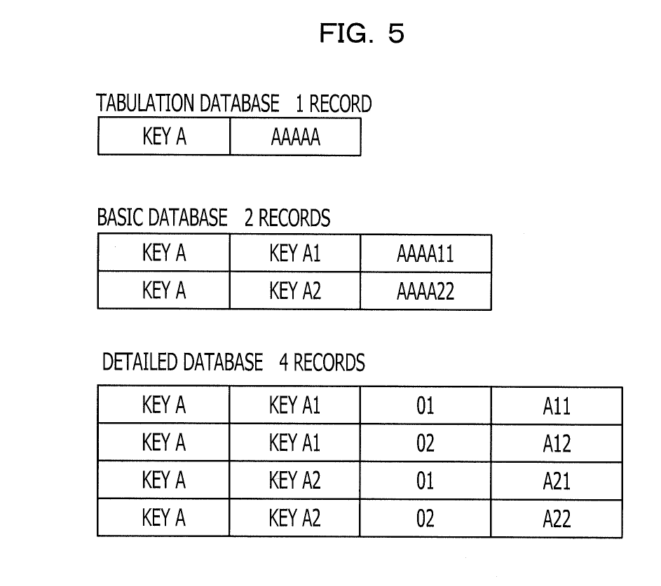

The digital signature device 10 searches each of the databases 151 to 153 for applicable records when the operation unit 17 accepts information that specifies a digital signature target record group (Operation S12). The digital signature device 10 outputs the search result to the RAM 13 by a dump format (Operation S13). The digital signature device 10 makes the RAM 13 store the dump format search result. FIG. 5 is a schematic view of an example of a search result. For example, at operation S11, when Key A is specified as a search key, a record in which “Key A” and “AAAAA” is associated is retrieved. Likewise, records in which “Key A”, “Key A1 (key 2)” and “AAAA11” are associated and records in which “Key A”, “Key A2 (key 2)” and “AAAA22” are associated are retrieved from the basic database 152 of FIG. 2B. The same applies to the detailed database 153 and four records are retrieved as illustrated in FIG. 5.

In FIG. 5, the search result is represented by table format data. However, in the device (RAM 13), the search result may be represented by binary dump format character strings.

The digital signature device 10 calculates a hash value from a dump format search result (Operation S14). The digital signature device 10 deletes the search result for which the hash value is calculated from the RAM. For a hash value calculation method, known methods may be used. For example, a hash value may be calculated by a hash function such as Secure Hash Algorithm 1 (SHA-1), and Message Digest Algorithm 5 (MD5) using a binary expression of a search result as a key.

According to the embodiment, a hash value is calculated. However, the embodiment is not limited to calculate a hash value as long as a value may be uniquely calculated by a certain algorithm using a search result as input data and the original data is difficult to calculate from the calculated value. For example, a pseudorandom number may be calculated instead of the hash value.

The digital signature device 10 makes the management table 155 store a calculated hash value (Operation S15). At the time, the signer inputs the name. The digital signature device 10 makes the management table 155 store, for example, signer information that is input through the operation unit 17, a digital signature number assigned by the digital signature device 10, a target database, a target key, and date and time of signature in association with the calculated hash value. Information that includes a target database and a target key is called signature target information.

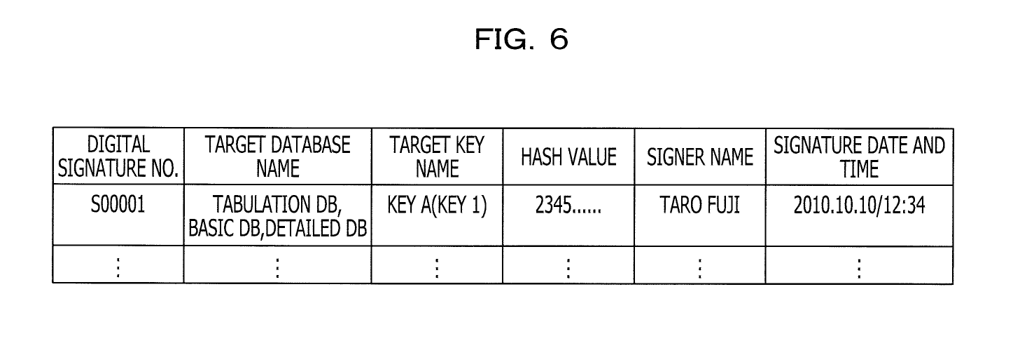

FIG. 6 is a schematic view of an example of a management table. The management table 155 associates and stores a digital signature number, a target database name, a target key name, a hash value, a signer's name, and date and time of signature. The signer, the date and time of the signature, and the signature target information may be identified by the management table 155. Accordingly, the digital signature device 10 may check a scope of the signature and the content from the management table 155.

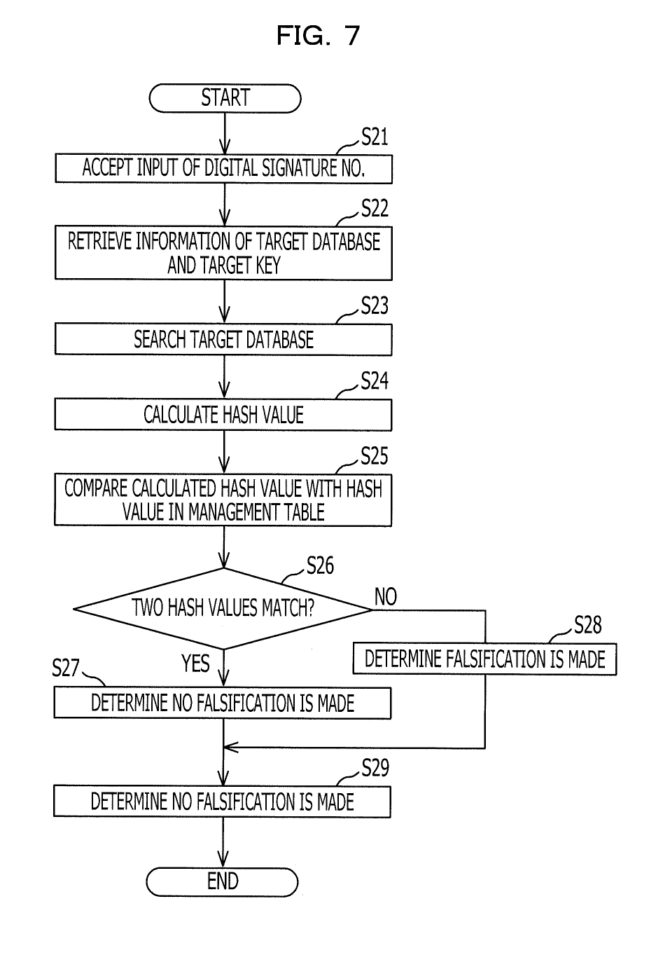

The processing procedure to determine falsification of information stored in each of the databases 151 to 153 will be described. FIG. 7 is a flow chart illustrating a processing procedure of falsification determination. The digital signature device 10 accepts a digital signature number (Operation S21). When a digital signature number is input through the operation unit 17 of the digital signature device 10, a hash value is calculated in substantially the same manner as applying a digital signature. For example, the management table 155 is searched using the digital signature number that is input at Operation S21 as a search key. The digital signature device 10 retrieves information of a target database and a target key stored in association with the digital signature number (Operation S22).

The digital signature device 10 searches the target database based on the retrieved information of the target database and the target key and generates dump format data that indicates the search result (Operation S23).

The digital signature device 10 calculates a hash value from the generated data using the algorithm used when the digital signature is applied (Operation S24).

The digital signature device 10 compares the calculated hash value with a hash value stored in the management table 155 in association with the input digital signature number (Operation S25). The digital signature device 10 determines whether the two hash values match (Operation S26).

If the two hash values match (Yes at Operation S26), the digital signature device 10 determines that information in each of the databases 151 to 153 is not falsified (Operation S27). On the other hand, if the two hash values do not match (No at Operation S26), the digital signature device 10 determines that any of the information in the databases 151 to 153 is falsified (Operation S28). The digital signature device 10 displays a determination result of either Operation S27 or Operation S28 in the display unit 16 (Operation S29).

Digital signature data generated by the digital signature device 10 according to the embodiment includes a hash value calculated based on a record group extracted from a database at certain time. Use of the hash value allows determining whether the database is falsified. Therefore, the digital signature device 10 according to the embodiment enables to certify validity at a certain time of contents of a database that is updated as needed. The validity of the contents indicates that data is not falsified according to the embodiment.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A digital signature device comprising:
an operation unit configured to accept key information that specifies target information of a digital signature from a user and to accept the digital signature from the user;
a control unit configured to extract one or more values that correspond to the key information that is accepted, from a database that stores a plurality of pieces of key information that includes the key information in association with each of the one or more values that are extracted, to calculate a characteristic value that is uniquely defined for each value based on the one or more values that are extracted, and to generate signature data that includes the key information, the characteristic value, and information for the digital signature for each of the one or more values; and
a storage unit configured to store the signature data.

2. The digital signature device according to claim 1, wherein the control unit calculates a hash value as the characteristic value.

3. The digital signature device according to claim 1, wherein the control unit stores the one or more values extracted from the database in a storage area as dump format data, and deletes dump format data that corresponds to the one or more values for which the characteristic value is calculated from the storage area when the characteristic value is calculated.

4. The digital signature device according to claim 2, wherein the control unit stores the one or more values extracted from the database in a storage area as dump format data and deletes the dump format data that corresponds to the one or more values for which the hash value is calculated from the storage area when the hash value is calculated.

5. The digital signature device according to claim 1, wherein
the storage unit stores the signature data in association with identification information that identifies the signature data;
the operation unit accepts the identification information;
the control unit extracts the characteristic value included in the signature data that corresponds to the identification information from the storage unit when the operation unit accepts the identification information, and retrieves a value that corresponds to the key information from the database based on the key information included in the signature data, newly calculates another characteristic value for the retrieved value, and determines whether any falsification is made based on a result of comparison of the characteristic value and the other characteristic value that are extracted.

6. The digital signature device according to claim 2, wherein
the storage unit stores the signature data in association with identification information that identifies the signature data;
the operation unit accepts the identification information; and
the control unit, when the control unit accepts the identification information, extracts the hash value included in the signature data that corresponds to the identification information from the storage unit, retrieves a value that corresponds to the key information from the database based on the key information included in the signature data, newly calculates another hash value for the value that is retrieved, and compares the hash value that is extracted with the other hash value and determines whether the value is falsified based on a result of the comparison.

7. The digital signature device according to claim 3, wherein
the storage unit stores the signature data in association with the identification information that identifies the signature data;
the operation unit accepts the identification information;
the control unit, when the operation unit accepts the identification information, extracts the characteristic value included in the signature data that corresponds to the identification information from the storage unit, retrieves a value that corresponds to the key information from the database based on the key information included in the signature data, newly calculates another characteristic value for the value that is retrieved, compares the characteristic value that is extracted with the other characteristic value, and determines whether the value that is retrieved is falsified based on a result of the comparison.

8. A digital signature method executed by a computer comprising:
accepting key information that specifies target information of a digital signature from a user;
extracting one or more values that correspond to the key information that is accepted, from a database that stores a plurality of pieces of key information that includes the key information in association with each of the one or more values that are extracted;
calculating a characteristic value that is uniquely defined for each of the one or more values based on the one or more values that are extracted;
accepting the digital signature from the user;
generating signature data that includes the key information, the characteristic value, and information for the digital signature for each of the one or more values; and
storing the signature data in a storage unit.

9. The digital signature method according to claim 8, wherein a hash value is calculated for the value as the characteristic value.

10. The digital signature method according to claim 8, further comprising:
storing the one or more values extracted from the database in a storage area as dump format data; and
deleting dump format data that corresponds to the one or more values for which the characteristic value is calculated from the storage area when the characteristic value is calculated.

11. The digital signature method according to claim 9, further comprising:
storing the one or more values extracted from the database in a storage area as dump format data; and
deleting the dump format data that corresponds to the one or more values for which the hash value is calculated from the storage area when the hash value is calculated.

12. The digital signature method according to claim 8, further comprising:
storing the signature data in association with identification information that identifies the signature data in the storage unit;
accepting the identification information from the user or another user;
extracting the characteristic value included in the signature data that corresponds to the identification information from the storage unit when the identification information is accepted;
retrieving a value that corresponds to the key information from the database based on the key information included in the signature data;
newly calculating another characteristic value for the retrieved value;
comparing the extracted characteristic value with the other characteristic value; and
determining whether the value that is retrieved is falsified based on a result of the comparing.

13. The digital signature method according to claim 9, further comprising:
storing the signature data in association with identification information that identifies the signature data in the storage unit;
accepting the identification information from the user or another user;
extracting the characteristic value included in the signature data that corresponds to the identification information from the storage unit when the identification information is accepted;
retrieving a value that corresponds to the key information from the database based on the key information included in the signature data;
newly calculating another characteristic value for the retrieved value;
comparing the extracted characteristic value with the other characteristic value; and
determining whether the value that is retrieved is falsified or not based on a result of the comparing.

14. The digital signature method according to claim 10, further comprising:
storing the signature data in association with identification information that identifies the signature data in the storage unit;
accepting the identification information from the user or another user;
extracting the characteristic value included in the signature data that corresponds to the identification information from the storage unit when the identification information is accepted;
retrieving a value that corresponds to the key information from the database based on the key information included in the signature data;
newly calculating another characteristic value for the value that is retrieved;
comparing the characteristic value that is extracted with the other characteristic value; and
determining whether the value that is retrieved is falsified based on a result of the comparing.

15. A non-transitory storage medium storing a digital signature program causing a computer to execute:
accepting key information that specifies target information of digital signature from a user;
extracting one or more values that correspond to the key information that is accepted, from a database that stores a plurality of pieces of key information that includes the key information in association with each of the one or more values that are extracted;
calculating a characteristic value that is uniquely defined for each of the one or more values based on the one or more values that are extracted;
accepting the digital signature from the user;
generating signature data that includes the key information, the characteristic value, and information for the digital signature for each of the one or more values; and
storing the signature data in a storage unit.

16. The digital signature program according to claim 15, wherein a hash value is calculated for the value as the characteristic value.

17. The non-transitory storage medium storing the digital signature program according to claim 15 causing the computer to further execute:
storing the one or more values extracted from the database in a storage unit as dump format data; and
deleting dump format data that corresponds to the one or more values for which the characteristic value is calculated from the storage area when the characteristic value is calculated.

18. The non-transitory storage medium storing the digital signature program according to claim 16 causing the computer to further execute:
storing the one or more values extracted from the database in a storage area as the dump format data; and
deleting dump format data that corresponds to the one or more values for which the hash value is calculated from the storage area when the hash value is calculated.

19. The non-transitory storage medium storing a digital signature program according to claim 15 causing the computer to further execute:
storing the signature data in association with identification information that identifies the signature data in the storage unit;
accepting the identification information from the user or another user;
extracting the characteristic value included in the signature data that corresponds to the identification information from the storage unit when the identification information is accepted;
retrieving a value that corresponds to the key information from the database based on the key information included in the signature data;
newly calculating another characteristic value for the value that is retrieved;
comparing the extracted characteristic value with the other characteristic value; and
determining whether the value that is retrieved is falsified based on a result of the comparing.

20. The non-transitory storage medium storing the digital signature program according to claim 16 causing the computer to further execute:
storing the signature data in association with identification information that identifies the signature data in the storage unit;
accepting the identification information from the user or another user;
extracting the characteristic value included in the signature data that corresponds to the identification information from the storage unit when the identification information is accepted;
retrieving a value that corresponds to the key information from the database based on the key information included in the signature data;
newly calculating another characteristic value for the value that is retrieved;
comparing the extracted characteristic value with the other characteristic value; and
determining whether the value that is retrieved is falsified based on a result of the comparing.
